(19) United States
(12) Patent Application Publication
(10) Pub. No.: US 2008/0049941 A1
(43) Pub. Date: Feb. 28, 2008

(54) METHOD FOR PROVIDING PERSONALIZED BROADCASTING SERVICE IN COMMUNICATION SYSTEM

(75) Inventors: Jun-Hyung KIM, Suwon-si (KR); Nae-Hyun LIM, Yongin-si (KR); Yong CHANG, Seongnam-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 11/843,991

(22) Filed: Aug. 23, 2007

(30) Foreign Application Priority Data
Aug. 24, 2006 (KR) 2006-80739

(51) Int. Cl. H04L 9/08; H04K 1/00

(52) U.S. Cl. 380/278; 380/44

(57) ABSTRACT

A method for providing personalized broadcasting contents by a transmitting Mobile Station (MS) in a communication system is provided. The method includes sharing a group identifier (ID), which is authority to receive the personalized broadcasting contents, with a receiving MS in advance, transmitting a first message including the group ID to a personalized broadcasting control station, receiving a second message including an encryption key from the personalized broadcasting control station, and encrypting the personalized broadcasting contents using the encryption key and transmitting the encrypted personalized broadcasting contents.

### PRIORITY

This application claims the benefit under 35 U.S.C. § 119(a) of a Korean patent application filed in the Korean Intellectual Property Office on Aug. 24, 2006 and assigned Serial No. 2006-80739, the entire disclosure of which is hereby incorporated by reference.

### BACKGROUND OF THE INVENTION

1. Field of the Invention

The present invention relates to a communication system. More particularly, the present invention relates to a method for providing a personalized broadcasting service.

2. Description of the Related Art

Communication systems have evolved from a stage of providing only a voice service to a stage of providing a voluminous and high-speed multimedia service. With the advance of communication systems, a broadcasting service has been also developed.

In an Institute of Electrical and Electronics Engineers (IEEE) 802.16 communication system, a broadcasting service is referred to as a Multi-Cast and Broad-Cast Service (MCBCS). Hereinafter, a broadcasting service will be referred to as an ‘MCBCS’.

The MCBCS can be classified into a single Base Station (BS) access scheme and a multiple BS access scheme according to a service access method of a Mobile Station (MS).

In the single BS access scheme, the MS receives an MCBCS from a single BS, whereas, in the multiple BS access scheme, the MS receives an MCBCS from at least two BSs at the same time.

FIGS. 1 and 2 illustrate the single BS access scheme and the multiple BS access scheme, respectively.

An MCBCS zone is used to distinguish MCBCS providing areas for each service. The MCBCS providing areas may be distinguished using different Connection Identifiers (CIDs) or different Security Associations (SAs). In other words, the MCBCS zone means a group of BSs using the same CID and SA for transmission of contents.

As the Internet culture has been diversified, contents created personally by common users instead of Internet service providers or content providers, i.e., so-called User Created Contents (UCC) or User Generated Contents (UGC) have come into the spotlight. However, a detailed method for providing personalized broadcasting contents such as the UCC through an uplink has not yet been defined. Moreover, a method for providing a personalized broadcasting service using an MCBCS system has not yet been defined, either.

### SUMMARY OF THE INVENTION

An aspect of the present invention is to address at least the above mentioned problems and/or disadvantages and to provide at least the advantages described below. Accordingly, an aspect of the present invention is to provide a method for providing a personalized broadcasting service in a communication system.

According to one aspect of the present invention, a method for providing personalized broadcasting contents by a transmitting Mobile Station (MS) in a communication system is provided. The method includes sharing a group identifier (ID), which is authority to receive the personalized broadcasting contents, with a receiving MS in advance, transmitting a first message including the group ID to a personalized broadcasting control station, receiving a second message including an encryption key from the personalized broadcasting control station, encrypting the personalized broadcasting contents using the encryption key and transmitting the encrypted personalized broadcasting contents.

According to another aspect of the present invention, a method for providing real-time personalized broadcasting contents by a personalized broadcasting control station in a communication system is provided. The method includes receiving a first message including a first group identifier (ID) from a transmitting Mobile Station (MS) that is to transmit the personalized broadcasting contents, generating an encryption key using the first group ID, transmitting a second message including the generated encryption key to the transmitting MS, establishing a multicast connection with at least one receiving MS that is to receive the personalized broadcasting contents, receiving a third message including a second group ID from the receiving MS, transmitting a fourth message including a decryption key corresponding to the second group ID to the receiving MS, and delivering the personalized broadcasting contents received from the transmitting MS to the receiving MS.

According to another aspect of the present invention, a method for providing non-real time personalized broadcasting contents by a personalized broadcasting control station in a communication system is provided. The method includes receiving a first message including a first group identifier (ID) and personalized broadcasting content information from a transmitting Mobile Station (MS) that is to transmit the personalized broadcasting contents, generating an encryption key using the first group ID, transmitting a second message including the generated encryption key and an address of a content server to the transmitting MS, transmitting a third message including the personalized broadcasting content information and a personalized broadcasting content ID to the content server, establishing a multicast connection with at least one receiving MS that is to receive the personalized broadcasting contents, receiving a fourth message including a second group ID from the receiving MS, transmitting a fifth message including a decryption key corresponding to the second group ID to the receiving MS, transmitting a sixth message requesting transmission of the personalized broadcasting contents of the transmitting MS to the content server, receiving the personalized broadcasting contents of the transmitting MS from the content server, and delivering the received personalized broadcasting contents to the receiving MS.

According to another aspect of the present invention, a method for a receiving Mobile Station (MS) to be provided with personalized broadcasting contents in a communication system is provided. The method includes sharing a group identifier (ID), which is authority to receive the personalized broadcasting contents, with a transmitting MS in advance, transmitting a first message including the group ID to a personalized broadcasting control station, receiving a second message including a decryption key from the personalized broadcasting control station, and receiving the personalized broadcasting contents from the personalized broadcasting control station using the decryption key.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 illustrates a singe Base Station (BS) access scheme;

FIG. 2 illustrates a multiple BS access scheme;

FIG. 3 illustrates a network structure for a personalized broadcasting service according to an exemplary embodiment of the present invention;

FIG. 4 is a signal flow diagram showing a process of providing non-real time personalized broadcasting contents according to an exemplary embodiment of the present invention;

FIG. 5 is a signal flow diagram showing a process of providing real-time personalized broadcasting contents according to an exemplary embodiment of the present invention;

FIG. 6 is a flowchart of a process of transmitting personalized broadcasting contents by a transmitting Mobile Station (MS) according to an exemplary embodiment of the present invention;

FIG. 7 is a flowchart of a process of providing personalized broadcasting contents by an MCBCS Controller (MCBCS-C) according to an exemplary embodiment of the present invention; and

FIG. 8 is a flowchart of a process of receiving personalized broadcasting contents by a receiving MS according to an exemplary embodiment of the present invention.

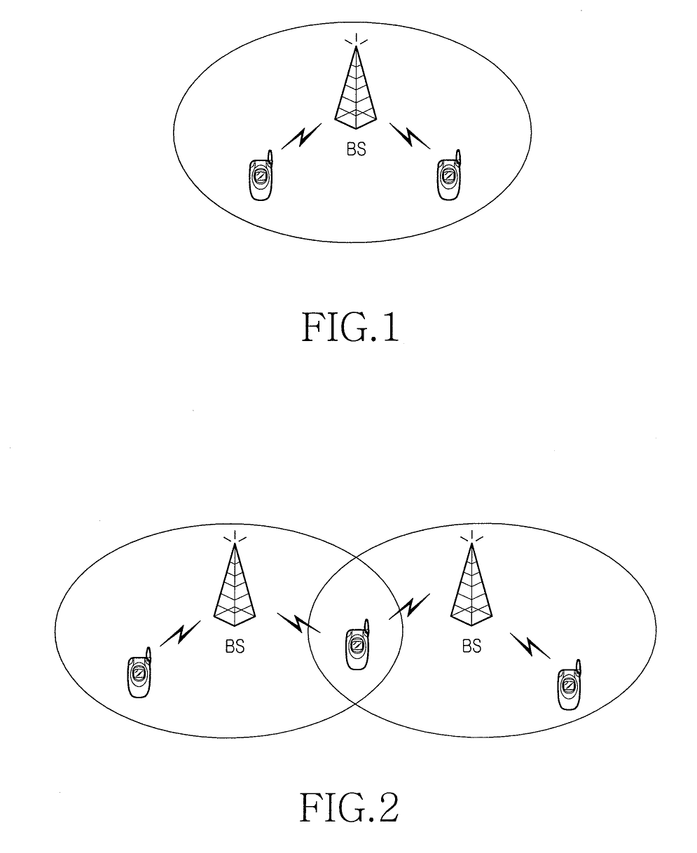

Throughout the drawings, the same drawing reference numerals will be understood to refer to the same elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiment described herein can be made without departing from the scope and spirit of the invention. Also, descriptions of well-known functions and constructions are omitted for clarity and conciseness.

The present invention suggests a method for providing a personalized broadcasting service. In particular, in exemplary embodiments of the present invention, a description will be made regarding a detailed procedure in which a transmitting (or originating) Mobile Station (MS) transmits personalized broadcasting contents through an uplink and a receiving (or terminating) MS receives the personalized broadcasting contents based on a Multi-Cast and Broad-Cast Service (MCBCS) system. An exemplary embodiment of the present invention can be applied to any communication system providing personalized broadcasting contents. In the following description, a personalized broadcasting service and personalized broadcasting contents will be used for the same meaning.

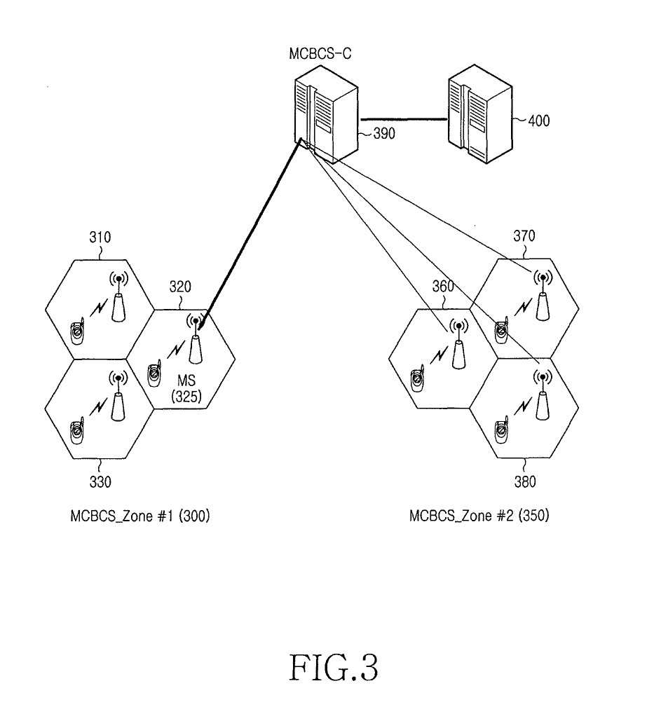

FIG. 3 illustrates a network structure for a personalized broadcasting service according to an exemplary embodiment of the present invention.

Referring to FIG. 3, a plurality of cells form a particular broadcasting area, i.e., an MCBCS zone, and each of them includes at least one MS. In FIG. 3, a cell 310, a cell 320 and a cell 330 constitute an MCBCS zone #1 300, and a cell 360, a cell 370 and a cell 380 constitute an MCBCS zone #2 350.

When an MS 325 located in the cell 320 transmits personalized broadcasting contents to MSs of the MCBCS zone #2 350, the personalized broadcasting contents of the MS 325 are transmitted to an MCBCS Controller (MCBCS-C) 390. The MSs of the MCBCS zone #2 350 are assumed to subscribe to a particular personalized broadcasting service in order to receive the personalized broadcasting contents of the MS 325.

The MCBCS-C 390 can store the personalized broadcasting contents transmitted from the MS 325 in a content server 400. The MCBCS-C 390 provides the personalized broadcasting contents stored in the content server 400 to the MSs of the MCBCS zone #2 350. When the personalized broadcasting contents of the MS 325 are real-time contents that are to be broadcast in real time, they may be provided to the MSs of the MCBCS zone #2 350 through the MCBCS-C 390 in real time without being stored in the content server 400.

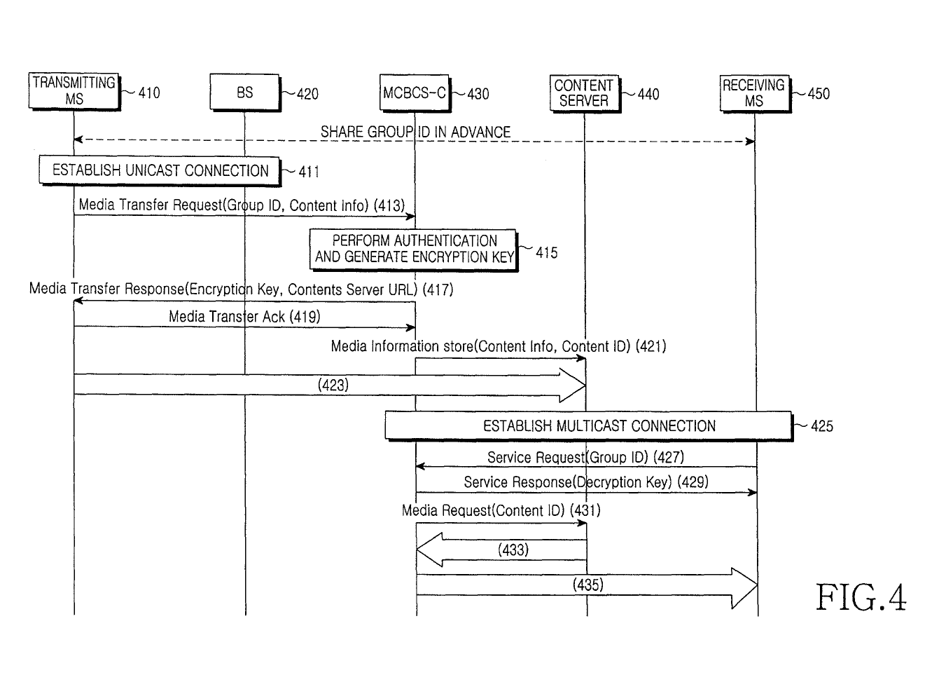

FIG. 4 is a signal flow diagram showing a process of providing non-real time personalized broadcasting contents that are to be provided in non-real time according to an exemplary embodiment of the present invention.

Referring to FIG. 4, a transmitting MS 410 transmitting non-real time personalized broadcasting contents and a receiving MS 450 receiving personalized broadcasting contents share a group ID in advance. The group ID indicates an ID assigned to MSs for particular personalized broadcasting contents, and the group ID can be shared using an e-mail, a community board or offline. The transmitting MS 410 establishes a unicast connection with a Base Station (BS) 420 in step 411.

The transmitting MS 410 transmits a media transfer request message to an MCBCS-C 430 in order to acquire information required for transmission of personalized broadcasting contents in step 413. The media transfer request message includes a group ID of the transmitting MS 410 and personalized broadcasting content information.

The MCBCS-C 430 generates an encryption key using the group ID in step 415. The MCBCS-C 430 transmits a media transfer response message including the generated encryption key and a Uniform Resource Locator (URL) of a content server 440 to the transmitting MS 410 in step 417. The transmitting MS 410 then can transmit personalized broadcasting contents after encrypting the personalized broadcasting contents using the encryption key.

The transmitting MS 410 receives the media transfer response message and transmits a media transfer acknowledgement (ACK) message to the MCBCS-C 430 in response to the media transfer response message in step 419.

The MCBCS-C 430 transmits a media information store message to the content server 440 in step 421. The media information store message includes personalized broadcasting content information and personalized broadcasting content ID information.

The transmitting MS 410 transmits media data corresponding to the personalized broadcasting contents to the content server 440 in step 423.

The receiving MS 450 establishes a multicast connection with the MCBCS-C 430 in step 425. The receiving MS 450 transmits a service request message for receiving the personalized broadcasting contents of the transmitting MS 410 to the MCBCS-C 430 in step 427. The service request message includes a group ID.

The MCBCS-C 430 transmits a service response message to the receiving MS 450 in response to the service request message in step 429. The service response message includes a decryption key. In other words, upon receipt of the group ID from the receiving MS 450, the MCBCS-C 430 recognizes that the receiving MS 450 is authorized to receive the personalized broadcasting contents of the transmitting MS 410. Thus, the MCBCS-C 430 transmits a media request message including a personalized broadcasting content ID to the content server 440 in step 431.

The content server 440 transmits personalized broadcasting contents corresponding to the personalized broadcasting content ID to the MCBCS-C 430 in step 433.

The MCBCS-C 430 transmits the personalized broadcasting contents to the receiving MS 450 in step 435.

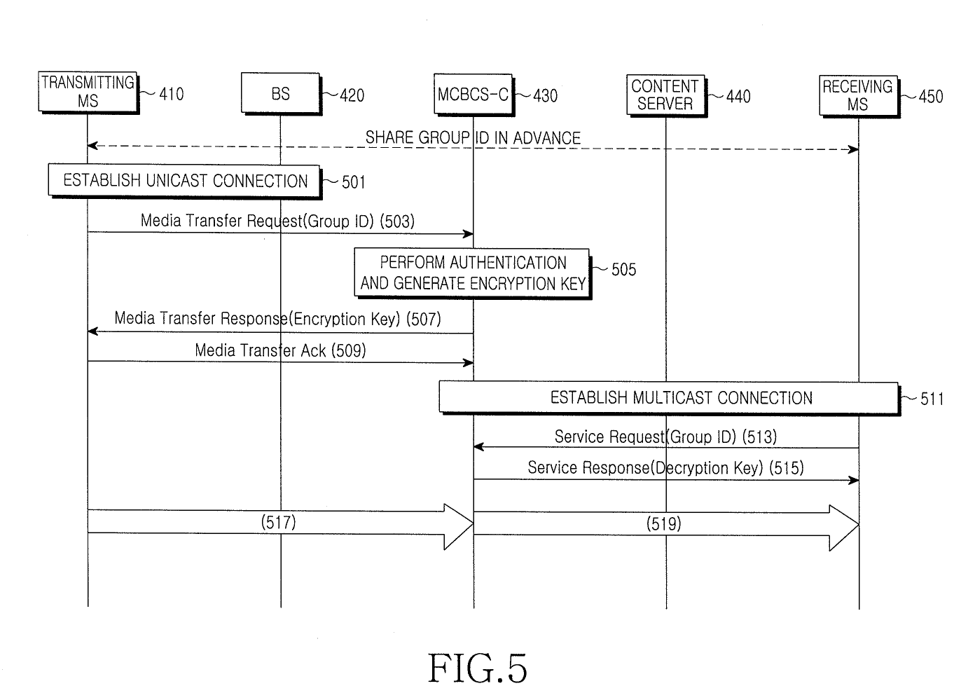

FIG. 5 is a signal flow diagram showing a process of providing real-time personalized broadcasting contents that have to be transmitted in real time according to an exemplary embodiment of the present invention.

Referring to FIG. 5, steps 501 through 509 are similar to steps 411 through 419 of FIG. 4 and steps 511 through 515 are similar to steps 425 through 429 of FIG. 4. However, real-time personalized broadcasting contents transmitted by the transmitting MS 410 are delivered to the receiving MS 450 through the MCBCS-C 430 in steps 517 and 519. In other words, the content server 440 does not store the personalized broadcasting contents. In addition, steps 503 and 507 are different from steps 413 and 417 of FIG. 4 in that a media transfer request message in step 503 includes only a group ID and a media transfer response message in step 507 includes only an encryption key.

If the receiving MS 450 is ready to receive the personalized broadcasting contents later than the transmission of the personalized broadcasting contents of the transmitting MS 410, the MCBCS-C 430 can store the personalized broadcasting contents in a buffer and then transmit the stored personalized broadcasting contents to the receiving MS 450. Step 517 can be performed at any point of time after step 509.

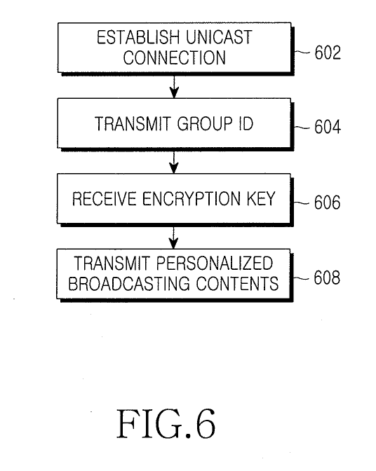

FIG. 6 is a flowchart of a process of transmitting personalized broadcasting contents by a transmitting MS according to an exemplary embodiment of the present invention.

Referring to FIG. 6, the transmitting MS establishes a unicast connection with a BS in step 602. The transmitting MS transmits a group ID to an MCBCS-C in step 604. The transmitting MS receives an encryption key used for encryption of the personalized broadcasting contents from the MCBCS-C in step 606. The transmitting MS transmits the personalized broadcasting contents in step 608. When the personalized broadcasting contents are real-time personalized broadcasting contents, the transmitting MS directly transmits the real-time personalized broadcasting contents to the MCBCS-C. When the personalized broadcasting contents are non-real time personalized broadcasting contents, the transmitting MS transmits the non-real time personalized broadcasting contents to a content server corresponding to a URL that is known in advance.

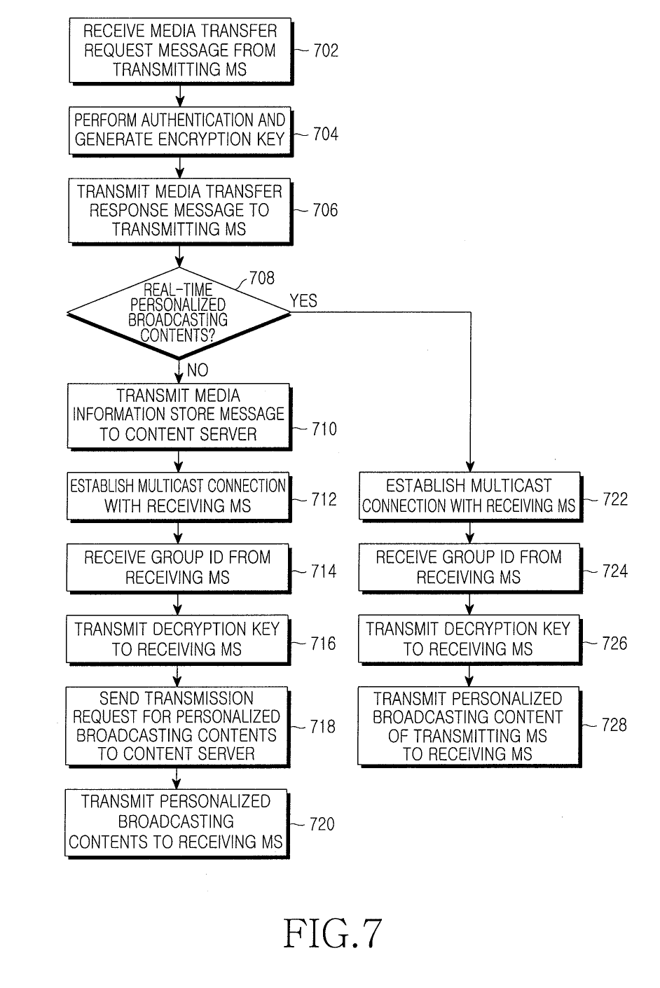

FIG. 7 is a flowchart of a process of providing personalized broadcasting contents by an MCBCS-C according to an exemplary embodiment of the present invention.

Referring to FIG. 7, the MCBCS-C receives a media transfer request message from a transmitting MS in step 702. The media transfer request message includes a group ID for real-time personalized broadcasting contents and includes a group ID and personalized broadcasting content information for non-real time personalized broadcasting contents. The MCBCS-C performs authentication on the transmitting MS and generates an encryption key using the received group ID in step 704.

The MCBCS-C transmits a media transfer response message to the transmitting MS in step 706. The media transfer response message includes an encryption key for real-time personalized broadcasting contents and includes an encryption key and a URL of a content server for non-real time personalized broadcasting contents.

In step 708, the MCBCS-C determines whether the personalized broadcasting contents to be transmitted by the transmitting MS are real-time personalized broadcasting contents. The MCBCS-C goes to step 710 for non-real time personalized broadcasting contents and goes to step 722 for real-time personalized broadcasting contents.

The MCBCS-C transmits a media information store message including personalized broadcasting content information and personalized broadcasting content ID information to a content server in step 710. The MCBCS-C establishes a multicast connection with the receiving MS in step 712 and receives a group ID from the receiving MS in step 714. The MCBCS-C then transmits a decryption key to the receiving MS in step 716. The MCBCS-C downloads the personalized broadcasting contents from the content server in step 718. The MCBCS-C transmits the personalized broadcasting contents of the transmitting MS to the receiving MS in step 720.

If it is determined in step 708 that real-time contents are to be broadcast, the MCBCS-C establishes a multicast connection with the receiving MS in step 722. The MCBCS-C receives a group ID from the receiving MS in step 724 and transmits a decryption key to the receiving MS in step 726. In step 728, the MCBCS-C transmits the personalized broadcasting contents of the transmitting MS to the receiving MS.

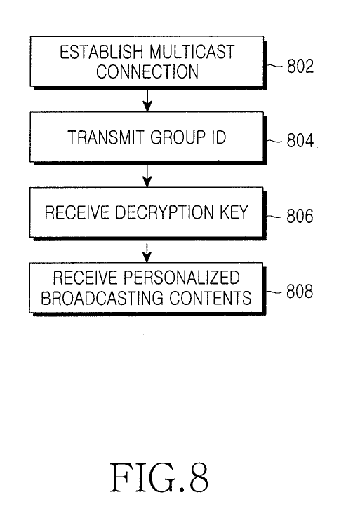

FIG. 8 is a flowchart of a process of receiving personalized broadcasting contents by a receiving MS according to an exemplary embodiment of the present invention.

Referring to FIG. 8, the receiving MS establishes a multicast connection with an MCBCS-C in step 802 and transmits a previously agreed group ID to the MCBCS-C in step 804. The receiving MS receives a decryption key from the MCBCS-C in step 806. The receiving MS then receives real-time personalized broadcasting contents from the MCBCS-C in step 808.

Real-time personalized broadcasting contents and non-real time personalized broadcasting contents may be provided using the following schemes.

First, personalized broadcasting contents may be provided to MSs included in a particular group in a multicast way. This scheme is useful for a case where the MSs included in the particular group are distributed over a wide area or have high mobility. In other words, an MCBCS-C provides personalized broadcasting contents in a multicast way to a BS where receiving MSs are located.

Second, personalized broadcasting contents are provided to all BSs included in a particular zone in a broadcast way. This scheme, which is similar to a multiple BS access scheme, can transmit a large amount of data using a small number of resources, thereby improving the efficiency of data transmission. In particular, this scheme is useful for an area where a plurality of receiving MSs having low mobility, such as at an apartment complex or a school, are located.

According to exemplary embodiments of the present invention, by providing a detailed method for providing personalized broadcasting contents, users can provide or be provided with a greater variety of broadcasting services.

While the invention has been shown and described with reference to exemplary embodiments thereof, it will be understood by those skilled in the art that various changes in form and details may be made therein without departing from the spirit and scope of the invention as defined by the appended claims and their equivalents.

What is claimed is:

1. A method for providing personalized broadcasting contents by a transmitting Mobile Station (MS) in a communication system, the method comprising:
sharing a group identifier (ID), comprising authority to receive the personalized broadcasting contents, with a receiving MS;
transmitting a first message including the group ID to a personalized broadcasting control station;
receiving a second message including an encryption key from the personalized broadcasting control station;
encrypting the personalized broadcasting contents using the encryption key; and
transmitting the encrypted personalized broadcasting contents.

2. The method of claim 1, wherein the sharing of the group ID with the receiving MS is performed before the transmitting of the first message.

3. The method of claim 1, wherein the transmitting of the encrypted personalized broadcasting contents comprises transmitting the encrypted personalized broadcasting contents to the personalized broadcasting control station when the personalized broadcasting contents comprise content that is to be transmitted in real time.

4. The method of claim 1, wherein the transmitting of the encrypted personalized broadcasting contents comprises transmitting the encrypted personalized broadcasting contents to a content server when the personalized broadcasting contents comprise content that is to be transmitted in non-real time.

5. The method of claim 4, wherein, if the transmitting MS transmits the non-real time personalized broadcasting contents, the first message further includes personalized broadcasting content information and the second message further includes an address of the content server.

6. A method for providing personalized broadcasting contents by a personalized broadcasting control station in a communication system, the method comprising:
receiving a first message including a first group identifier (ID) from a transmitting Mobile Station (MS) that is to transmit the personalized broadcasting contents;
generating an encryption key using the first group ID;
transmitting a second message including the generated encryption key to the transmitting MS;
establishing a multicast connection with at least one receiving MS that is to receive the personalized broadcasting contents;
receiving a third message including a second group ID from the at least one receiving MS;
transmitting a fourth message including a decryption key corresponding to the second group ID to the at least one receiving MS; and
delivering the personalized broadcasting contents to the at least one receiving MS.

7. The method of claim 6, wherein the delivering of the personalized broadcasting contents comprises delivering personalized broadcasting contents received from the transmitting MS when the personalized broadcasting content comprises content that is to be transmitted in real time.

8. The method of claim 6, wherein the first group ID further comprises personalized broadcasting content information when the personalized broadcasting content comprises content that is to be transmitted in non-real time.

9. The method of claim 8, wherein the second message further comprises an address of a content server.

10. The method of claim 9, further comprising transmitting a message including the personalized broadcasting content information and a personalized broadcasting content ID to the content server.

11. The method of claim 10, further comprising transmitting a message requesting transmission of the personalized broadcasting contents of the transmitting MS to the content server.

12. The method of claim 11, further comprising receiving the personalized broadcasting contents of the transmitting MS from the content server.

13. A method for receiving personalized broadcasting contents by a receiving Mobile Station (MS) in a communication system, the method comprising:
sharing a group identifier (ID), comprising authority to receive the personalized broadcasting contents, with a transmitting MS;
transmitting a first message including the group ID to a personalized broadcasting control station;
receiving a second message including a decryption key from the personalized broadcasting control station; and
receiving the personalized broadcasting contents from the personalized broadcasting control station using the decryption key.

14. The method of claim 13, wherein the sharing of the group ID with the transmitting MS is performed before the transmitting of the first message.
